(19) United States
(12) Patent Application Publication
(10) Pub. No.: US 2006/0063138 A1
(43) Pub. Date: Mar. 23, 2006

(54) Methods and systems for adapting data from a user interface

(75) Inventors: Gisbert R. Loff, Hockenheim (DE); Christian Cohrs, Sandhausen (DE)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: SAP Aktiengesellschaft

(21) Appl. No.: 10/941,909

(22) Filed: Sep. 16, 2004

(51) Int. Cl. G09B 21/00

(52) U.S. Cl. 434/112

(57) ABSTRACT

Systems and methods are disclosed for adapting data from a user interface. The disclosed systems and methods may include creating an identification associated with at least one screen on the user interface. The at least one screen may be produced by an executed software module. The disclosed systems and methods may further include receiving accessibility information associated with the at least one screen on the user interface and storing the identification and the accessibility information. Furthermore, the disclosed systems and methods may include driving the user interface with an executed software module, wherein the user interface is configured to display the at least one screen having an identification. In addition, the disclosed systems and methods may include accessing accessibility information based on the identification and providing the accessibility information.

### BACKGROUND OF THE INVENTION

I. Field of the Invention

The present invention generally relates to methods and systems for adapting data from a user interface. More particularly, the present invention relates to adapting data from a user interface for a user having a disability, for example.

II. Background Information

Many computer users have disabilities that make it difficult or even impossible for the computer user to use conventional computer input or output devices. To compensate for their disabilities, such disabled computer users may use screen reader systems to support their computer use. Such screen reader systems for supporting disabled computer users often use a screen reader software package.

FIG. 1 shows a conventional screen reader system 100. System 100 may execute a conventional screen reader software package that receives a computer screen's textual content and converts that content, for example, to synthesized human speech or Braille. As shown in FIG. 1, a computer 105 may include a user interface comprising a screen 110. In addition, computer 105 may include a speaker 115 and/or a Braille display 120. In executing the conventional screen reader software package, computer 105, having an internal software speech synthesizer (not shown) and a sound card (not shown) for example, may read aloud information from screen 110 on speaker 115. Or the conventional screen reader software package executed on computer 105 may display the information from screen 110 on Braille display 120. JAWS® for Windows, marketed by Freedom Scientific of St. Petersburg, Fla., is an example of a conventional screen reader software package having the aforementioned capabilities.

In some situations, however, conventional systems for supporting disabled computer users, such as system 100, may not adapt well to some computer applications. For example, conventional systems may be able to identify popular personal computer application icons, but cannot be used on generic applications having more generic screen content renderings. While vendors providing such generic applications may also provide interfaces to conventional screen readers, many vendors may find such interfaces too expensive to provide. Or even if the vendors provided such interfaces, users may not upgrade to applications that include such interfaces. This often causes problems because the conventional systems do not support generic applications, such as client/server applications that provide generic screen content renderings. In addition, conventional systems may not provide enough information for a disabled user to use the application.

In view of the foregoing, there is a need for methods and systems for adapting data from a user interface more optimally. Furthermore, there is a need for adapting data from a user interface for a user having a disability, for example.

### SUMMARY OF THE INVENTION

Consistent with embodiments of the present invention, systems and methods are disclosed for adapting data from a user interface.

In accordance with one embodiment, a method for adapting data from a user interface comprises creating an identification associated with at least one screen on the user interface, the at least one screen being produced by an executed software module, receiving accessibility information associated with the at least one screen, and storing the identification and the accessibility information.

According to another embodiment, a method for adapting data from a user interface comprises driving the user interface with an executed software module, the user interface displaying at least one screen, the at least one screen having an identification, accessing accessibility information based on the identification, and providing the accessibility information.

In accordance with yet another embodiment, a system for adapting data from a user interface comprises a memory storage for maintaining a database and a processing unit coupled to the memory storage, wherein the processing unit is operative to create an identification associated with at least one screen on the user interface, the at least one screen being produced by an executed software module, receive accessibility information associated with the at least one screen, and store the identification and the accessibility information.

In accordance with yet another embodiment, a system for adapting data from a user interface comprises a memory storage for maintaining a database and a processing unit coupled to the memory storage, wherein the processing unit is operative to drive the user interface with an executed software module, the user interface displaying at least one screen, the at least one screen having an identification, access accessibility information based on the identification, and provide the accessibility information.

In accordance with yet another embodiment, a computer-readable medium which stores a set of instructions which when executed performs a method for adapting data from a user interface, the method executed by the set of instructions comprising creating an identification associated with at least one screen on the user interface, the at least one screen being produced by an executed software module, receiving accessibility information associated with the at least one screen, and storing the identification and the accessibility information.

In accordance with yet another embodiment, a computer-readable medium which stores a set of instructions which when executed performs a computer-readable medium for adapting data from a user interface, the computer-readable medium executed by the set of instructions comprising driving the user interface with an executed software module, the user interface displaying at least one screen, the at least one screen having an identification, accessing accessibility information based on the identification, and providing the accessibility information.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of a conventional screen reader system;

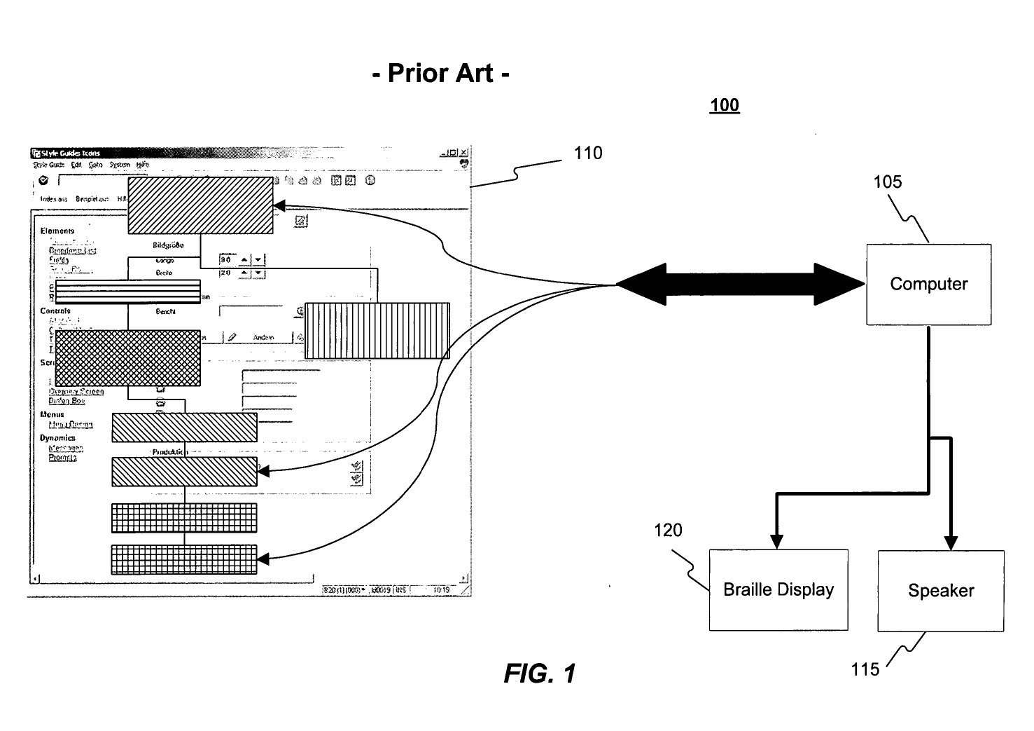

FIG. 2 is a block diagram of an exemplary user interface adapting system consistent with an embodiment of the present invention;

FIG. 3 is a block diagram of another exemplary user interface adapting system consistent with an embodiment of the present invention;

FIG. 4 is a block diagram of yet another exemplary interface adapting system consistent with an embodiment of the present invention;

FIG. 5 is a flow chart of an exemplary method for adapting data from a user interface consistent with an embodiment of the present invention; and

FIG. 6 is a flow chart of another exemplary method for adapting data from a user interface consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

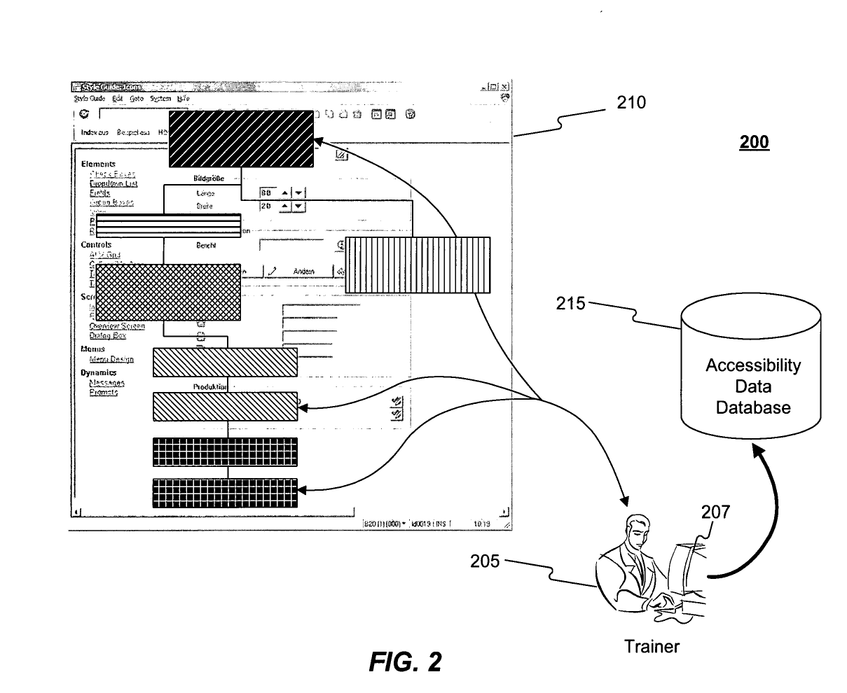

Systems and methods consistent with embodiments of the present invention may adapt data from a user interface. FIG. 2 is a block diagram of an exemplary user interface adapting system 200 consistent with an embodiment of the present invention. As shown in FIG. 2, a trainer 205 may execute an application program on a trainer processor 207 (described in more detail below) and observe a user interface 210 associated with the application program. User interface 210 may comprise, but is not limited to, a monitor that may display a screen or series of screens produced by the executed application program. While observing the screen or series of screens associated with user interface 210, trainer 205 may gather accessibility information. The accessibility information may comprise any data or information that may help or enrich an impaired user in using the observed screen associated with the accessibility information. Furthermore, the accessibility information, for example, may comprise data or information that may be used with a screen reader software module to facilitate a disabled user's computer use. The accessibility information may facilitate the disabled user's computer use in accessing screens that otherwise may not be accessible with a conventional screen reader system. The accessibility information may comprise, for example, data associated with titles for tables on given screens or links between fields and labels on given screens. The accessibility information gathered by trainer 205 may be entered into trainer processor 207 and stored in an accessibility data database 215. Database 215 may be made available, for example, to any user or users within an enterprise.

Linking accessibility information to a screen associated with user interface 210 may be accomplished by giving the screen a unique identification (ID). The ID may be generated, for example, by using an existing screen ID within an application program that produced the screen on user interface 210. Or the ID may be generated by using a hash algorithm on data associated with the screen. The accessibility information associated with the screen may be tagged with the ID associated with the screen. The accessibility information tagged with the ID may be stored in database 215.

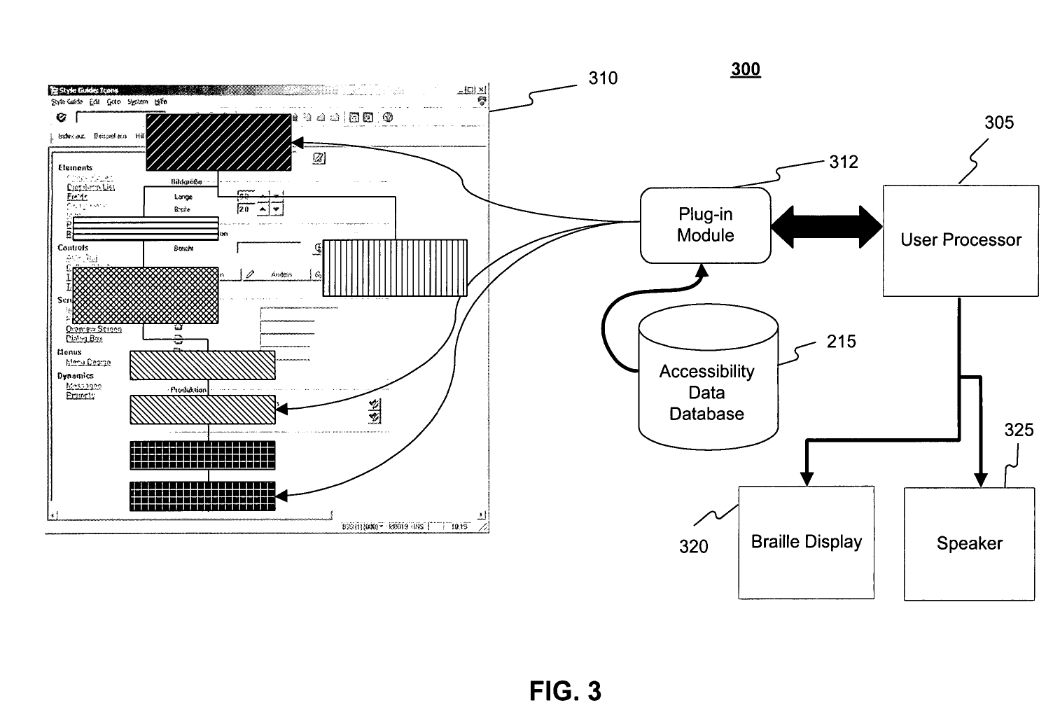

FIG. 3 is a block diagram of another exemplary user interface adapting system 300 consistent with an embodiment of the present invention. As shown in FIG. 3, when a disabled user runs an application program on user processor 305 (described in more detail below), a screen reader software module used by the disabled user may detect that accessibility information exists for screens displayed on a user interface 310. In addition, for example, a plug-in module 312 may be called by the screen reader software module to interface between database 215 and the screen reader software module and detect that additional accessibility information is available on database 215. Accordingly, the screen reader software module may access database 215 (through plug-in module 312) to retrieve that accessibility information. Furthermore, the screen reader software module may display the accessibility information, for example, on a Braille display 320 or audibly over a speaker 325.

An embodiment consistent with the invention may comprise a system for adapting data from a user interface. The system may comprise a memory storage for maintaining a database and a processing unit coupled to the memory storage. The processing unit may be operative to create an identification associated with at least one screen on the user interface, the at least one screen being produced by an executed software module. Furthermore, the processing unit may be operative to receive accessibility information associated with the at least one screen and to store the identification and the accessibility information.

Another embodiment consistent with the invention may also comprise a system for adapting a user interface. This system may also comprise a memory storage for maintaining a database and a processing unit coupled to the memory storage. The processing unit may be operative to drive the user interface with an executed software module, the user interface displaying at least one screen, the at least one screen having an identification. Moreover, the processing unit may be operative to access accessibility information based on the identification and provide the accessibility information.

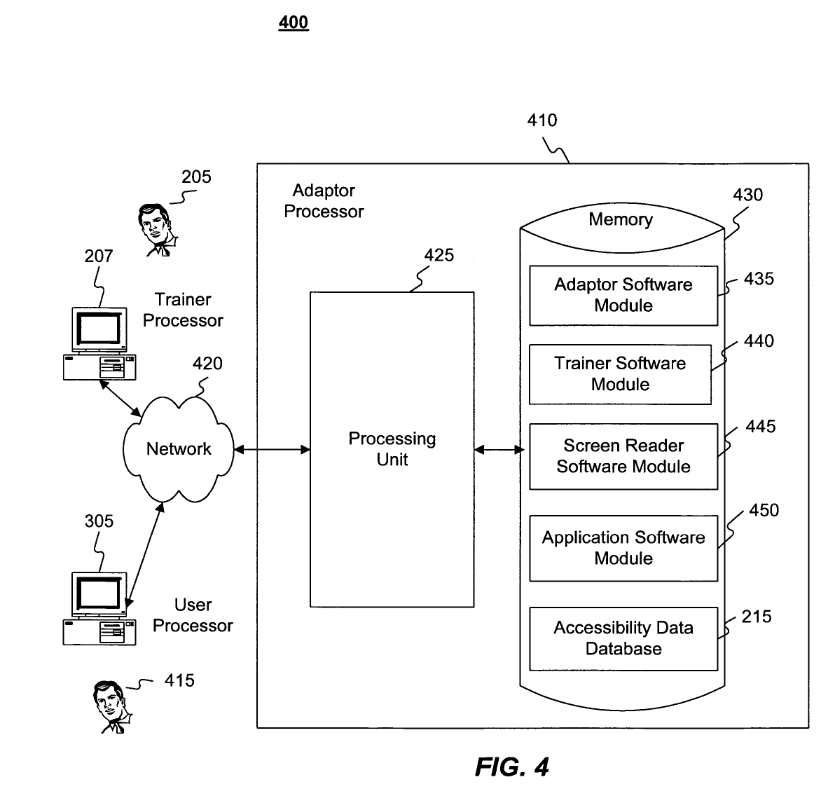

Consistent with an embodiment of the present invention, the aforementioned memory, processing unit, and other components may be implemented in an interface adapting system, such as an exemplary interface adapting system 400 of FIG. 4. Any suitable combination of hardware, software and/or firmware may be used to implement the memory, processing unit, or other components. By way of example, the memory, processing unit, or other components may be implemented with any of user processor 305, trainer processor 207, or an adaptor processor 410, in combination with system 400. The aforementioned system and processors are exemplary and other systems and processors may comprise the aforementioned memory, processing unit, or other components, consistent with embodiments of the present invention.

Furthermore, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

By way of a non-limiting example, FIG. 4 illustrates system 400 in which the features and principles of the present invention may be implemented. As illustrated in the block diagram of FIG. 4, system 400 may include user processor 305, trainer processor 207, adaptor processor 410, a user 415, trainer 205, and a network 420. User 415 may be, but is not limited to, an individual, for example, desiring to receive accessibility data using system 400. Furthermore, trainer 205 may be, but is not limited to, an individual, for example, desiring to create accessibility data using system 400.

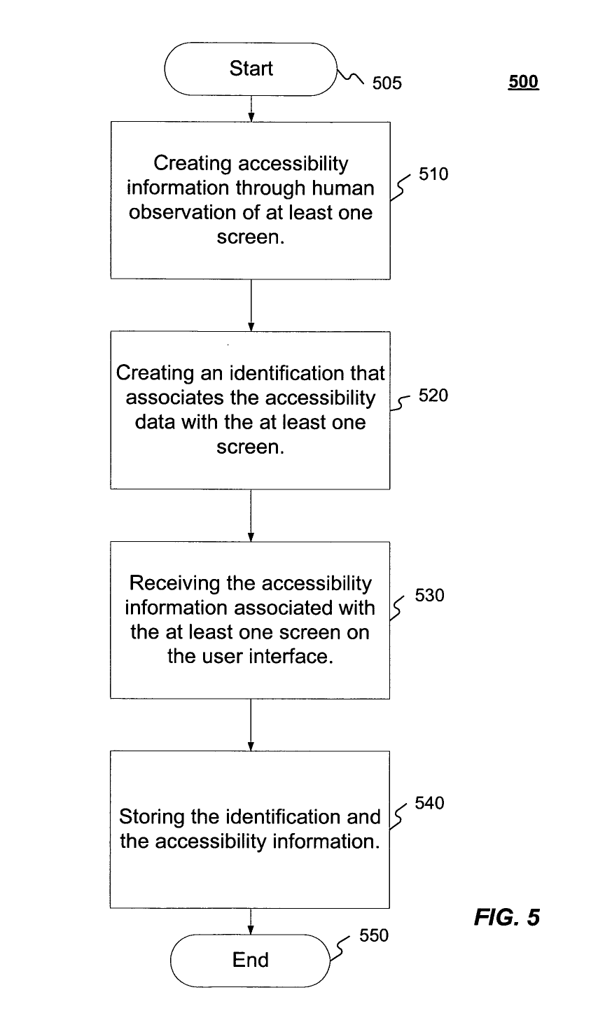

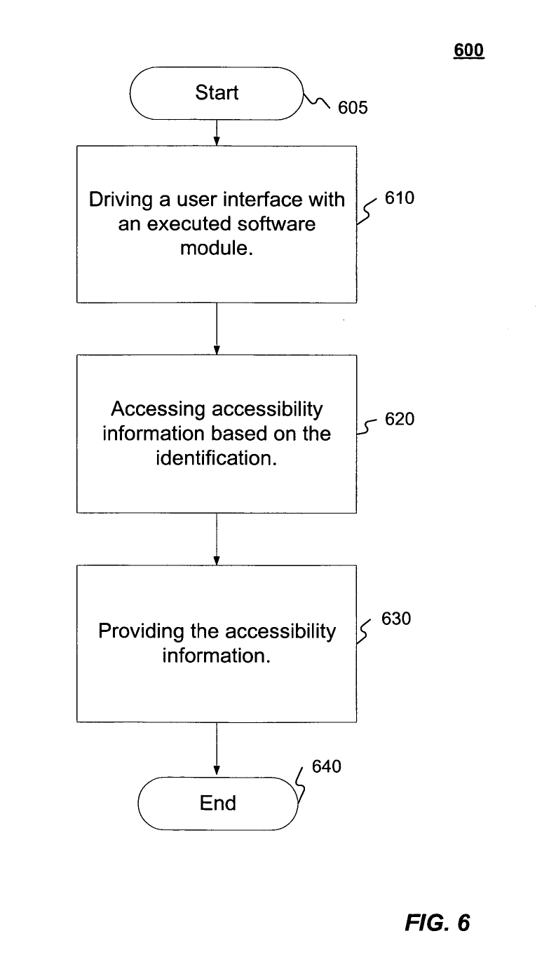

Adaptor processor 410 may include a processing unit 425 and a memory 430. Memory 430 may include: i) an adaptor software module 435; ii) a trainer software module 440; iii) a screen reader software module 445; iv) an application software module 450; and v) accessibility data database 215. The software modules 435 through 450, residing in memory 430, may be executed on processing unit 425 and may access accessibility data database 215. For example, one or combinations of the aforementioned software modules, executed on processing unit 425, may access database 215 and implement processes for adapting a user interface such as, but not limited to, the methods described below with respect to FIGS. 5 and 6. In addition, the aforementioned software modules are not limited to adaptor processor 410 and may reside and/or be executed on any processor (or combination of processors) including, for example, user processor 305, trainer processor 207, and adaptor processor 410.

User processor 305, trainer processor 207, or adaptor processor 410 (“the processors”) included in system 400 may be implemented using a personal computer, network computer, mainframe, or other similar microcomputer-based workstation. The processors may though comprise any type of computer operating environment, such as hand-held devices, multiprocessor systems, microprocessor-based or programmable sender electronic devices, minicomputers, mainframe computers, and the like. The processors may also be practiced in distributed computing environments where tasks are performed by remote processing devices. Furthermore, any of the processors may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the processor may comprise other systems or devices.

Network 420 may comprise, for example, a local area network (LAN) or a wide area network (WAN). Such networking environments are commonplace in offices, enterprise-wide computer networks, intranets, and the Internet, and are known by those skilled in the art. When a LAN is used as network 420, a network interface located at any of the processors may be used to interconnect any of the processors. When network 420 is implemented in a WAN networking environment, such as the Internet, the processors may typically include an internal or external modem (not shown) or other means for establishing communications over the WAN. Further, in utilizing network 420, data sent over network 420 may be encrypted to insure data security by using known encryption/decryption techniques.

In addition to utilizing a wire line communications system as network 420, a wireless communications system, or a combination of wire line and wireless may be utilized as network 420 in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The processors in the wireless environment can be any mobile terminal, such as the mobile terminals described above. Wireless data may include, but is not limited to, paging, text messaging, e-mail, Internet access and other specialized data applications specifically excluding or including voice transmission.

System 400 may also transmit data by methods and processes other than, or in combination with, network 420. These methods and processes may include, but are not limited to, transferring data via diskette, CD ROM, facsimile, conventional mail, an interactive voice response system (IVR), memory sticks, or via voice over a publicly switched telephone network.

FIG. 5 is a flow chart setting forth the general stages involved in an exemplary method 500 consistent with the invention for adapting data from a user interface using system 400 of FIG. 4. Exemplary ways to implement the stages of exemplary method 500 will be described in greater detail below. Exemplary method 500 may begin at starting block 505 and proceed to stage 510 where trainer 205, using trainer processor 207 and executing trainer software module 440, may create accessibility information. Trainer 205 may create accessibility information through, for example, observing a screen or screens shown on a user interface associated with trainer processor 207. The user interface may comprise, but is not limited to a monitor connected to trainer processor 207. The observed screens may be produced and shown on the user interface by application software module 450 being executed on, for example, trainer processor 207. Trainer 205 may enter data corresponding to the accessible information in trainer processor 207.

The accessibility information may comprise any data or information that may help or enrich a disabled user in using the screen associated with the accessibility information. The accessibility information may comprise, for example, data associated with titles for tables on given screens associated with the accessibility information. Furthermore, the accessibility information may comprise data associated with links between fields and labels on given screens.

Regardless of the form the accessibility information takes, the accessibility information may comprise information configured to be perceivable by a user having a disability such as the inability to perceive a human sense. The disability may comprise, but is not limited to, the inability to see and/or to hear. Furthermore, the accessibility information may be configured to be used by screen reader software module 445. For example, if the accessibility information is intended for a user unable to hear or see, the accessibility information may be in a form readily producible by screen reader software module 445 to a Braille display. If, on the other hand, the accessibility information is intended for a user unable to see, but able to hear, the accessibility information may be in a form readily producible by screen reader software module 445 to a speaker in audible form.

From stage 510, where trainer 205 creates the accessibility information, exemplary method 500 may advance to stage 520 where either adaptor processor 410 or trainer processor 207 may create an identification (ID). The ID may be used to associate the accessibility data with a screen that the accessibility data describes. For example, each screen may be given a unique ID. The unique ID may be generated, for example, by adapter software module 440 using existing screen IDs produced by application software module 450. Or adapter software module 440 may generate the ID using a hash algorithm on data associated with the screen. In creating the ID, the hash algorithm may turn a variable-sized amount of text or layout information associated with the screen into a fixed-sized output (hash value). Hash functions may be used in creating digital signatures, hash tables, and short condensations of text for analysis purposes.

Once either adaptor processor 410 or trainer processor 207 creates the ID in stage 520, exemplary method 500 may continue to stage 530 where adaptor processor 410 may receive the accessibility information. For example, trainer 205 may send the accessibility information created using trainer software module 440 to adaptor processor 410 over network 420. At this point, the accessibility information may be tagged with the corresponding ID associated with the screen described by the accessibility information.

After adaptor processor 410 receives the accessibility information in stage 530, exemplary method 500 may proceed to stage 540 where adaptor processor 410 may store the identification and the accessibility information. For example, accessibility information associated with a given screen may be tagged with the ID associated with the given screen described by the accessibility information and may be stored in database 215. After adaptor processor 410 stores the identification and the accessibility information in stage 540, exemplary method 500 may then end at stage 550.

FIG. 6 is a flow chart setting forth the general stages involved in another exemplary method 600 consistent with the invention for adapting data from a user interface using system 400 of FIG. 4. Exemplary ways to implement the stages of exemplary method 600 will be described in greater detail below. Exemplary method 600 may begin at starting block 605 and proceed to stage 610 where user processor 405 or adaptor processor 410 may drive a user interface with an executed software module. For example, user processor 305 or adaptor processor 410, under the direction of user 415, for example, may execute application software module 450. Application software module 450 may produce a screen or screens displayable on a user interface associated with user processor 305. In driving the user interface, it is not necessary for the screen to actually be displayed on the user interface, although the screen may be displayed. The user interface may comprise, but is not limited to, a monitor connected to user processor 305. Furthermore, the displayable screen or screens may each have a unique identification (ID) as described above.

From stage 610, where user processor 305 drives the user interface, exemplary method 600 may advance to stage 620 where user processor 305 may access accessibility information based on the identification associated with the screen displayed on the user interface. For example, user processor 305 may access accessibility data database 215 over network 420. User processor 305 may query accessibility data database 215 using the ID associated with the displayable screen to obtain accessibility information based on the ID. Once user processor 305 accesses accessibility information in stage 620, exemplary method 600 may continue to stage 630 where user processor 305 may provide the accessibility information. For example, user processor 415 may provide the accessibility information on a Braille display or audibly over a speaker. Furthermore, the accessibility information and the screen associated with the accessibility information may be provided to user 405 substantially simultaneously. After user processor 305 provides the accessibility information in stage 630, exemplary method 600 may then end at stage 640.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A method for adapting data from a user interface, the method comprising:
creating an identification associated with at least one screen on the user interface, the at least one screen being produced by an executed software module;
receiving accessibility information associated with the at least one screen; and
storing the identification and the accessibility information.

2. The method of claim 1, wherein receiving the accessibility information further comprises receiving the accessibility information configured to be perceivable by a user having a disability.

3. The method of claim 1, wherein receiving the accessibility information further comprises receiving the accessibility information configured to be perceivable by a user having a disability comprising the inability to perceive at least one human sense.

4. The method of claim 1, wherein receiving the accessibility information further comprises receiving the accessibility information configured to be perceivable by a user having a disability comprising the inability to perceive at least one of sight and sound.

5. The method of claim 1, wherein receiving the accessibility information further comprises receiving the accessibility information configured to be used by a screen reader.

6. The method of claim 1, wherein receiving the accessibility information further comprises receiving the accessibility information configured to be used by a device capable of reproducing the accessibility information in at least one of audible form and Braille form.

7. The method of claim 1, wherein receiving the accessibility information further comprises receiving the accessibility information comprising at least one of layout information associated with the at least one screen and content information associated with the at least one screen.

8. The method of claim 1, wherein creating the identification further comprises using a hash algorithm.

9. The method of claim 1, further comprising creating the accessibility information through human observation of the at least one screen.

10. A method for adapting data from a user interface, the method comprising:
driving the user interface with an executed software module, the user interface configured to display at least one screen, the at least one screen having an identification;
accessing accessibility information based on the identification; and
providing the accessibility information.

11. The method of claim 10, wherein providing the accessibility information further comprises providing the accessibility information configured to be perceivable by a user having a disability.

12. The method of claim 10, wherein providing the accessibility information further comprises providing the accessibility information configured to be perceivable by a user having a disability comprising the inability to perceive at least one human sense.

13. The method of claim 10, wherein providing the accessibility information further comprises providing the accessibility information configured to be perceivable by a user having a disability comprising the inability to perceive at least one of sight and sound.

14. The method of claim 10, wherein providing the accessibility information further comprises using a screen reader.

15. The method of claim 10, wherein providing the accessibility information further comprises providing the accessibility using a device capable of producing the accessibility information in at least one of audible form and Braille form.

16. The method of claim 10, wherein providing the accessibility information further comprises providing the accessibility information comprising at least one of layout information associated with the at least one screen and content information associated with the at least one screen.

17. The method of claim 10, wherein accessing accessibility information based on the identification further comprises accessing accessibility information based on the identification wherein the identification was created using a hash algorithm.

18. The method of claim 10, wherein providing the accessibility information further comprises providing the accessibility information created through human observation of the at least one screen.

19. A system for adapting data from a user interface, the system comprising:
a memory storage for maintaining a database; and
a processing unit coupled to the memory storage, wherein the processing unit is operative to
create an identification associated with at least one screen on the user interface, the at least one screen being produced by an executed software module;
receive accessibility information associated with the at least one screen; and
store the identification and the accessibility information.

20. The system of claim 19, wherein the processing unit being operative to receive the accessibility information further comprises the processing unit being operative to receive the accessibility information configured to be perceivable by a user having a disability.

21. The system of claim 19, wherein the processing unit being operative to receive the accessibility information further comprises the processing unit being operative to receive the accessibility information configured to be perceivable by a user having a disability comprising the inability to perceive at least one human sense.

22. The system of claim 19, wherein the processing unit being operative to receive the accessibility information further comprises the processing unit being operative to receive the accessibility information configured to be perceivable by a user having a disability comprising the inability to perceive at least one of sight and sound.

23. The system of claim 19, wherein the processing unit being operative to receive the accessibility information further comprises the processing unit being operative to receive the accessibility information configured to be used by a screen reader.

24. The system of claim 19, wherein the processing unit being operative to receive the accessibility information further comprises the processing unit being operative to receive the accessibility information configured to be used by a device capable of reproducing the accessibility information in at least one of audible form and Braille form.

25. The system of claim 19, wherein the processing unit being operative to receive the accessibility information further comprises the processing unit being operative to receive the accessibility information comprising at least one of layout information associated with the at least one screen and content information associated with the at least one screen.

26. The system of claim 19, wherein the processing unit being operative to create the identification further comprises the processing unit being operative to use a hash algorithm.

27. The system of claim 19, wherein the processing unit is further operative to create the accessibility information through human observation of the at least one screen.

28. A system for adapting data from a user interface, the system comprising:
a memory storage for maintaining a database; and
a processing unit coupled to the memory storage, wherein the processing unit is operative to
driving the user interface with an executed software module, the user interface configured to display at least one screen, the at least one screen having an identification;
access accessibility information based on the identification; and
provide the accessibility information.

29. The system of claim 28, wherein the processing unit being operative to provide the accessibility information further comprises the processing unit being operative to provide the accessibility information configured to be perceivable by a user having a disability.

30. The system of claim 28, wherein the processing unit being operative to provide the accessibility information further comprises the processing unit being operative to provide the accessibility information configured to be perceivable by a user having a disability comprising the inability to perceive at least one human sense.

31. The system of claim 28, wherein the processing unit being operative to provide the accessibility information further comprises the processing unit being operative to provide the accessibility information configured to be perceivable by a user having a disability comprising the inability to perceive at least one of sight and sound.

32. The system of claim 28, wherein the processing unit being operative to provide the accessibility information further comprises the processing unit being operative to use a screen reader.

33. The system of claim 28, wherein the processing unit being operative to provide the accessibility information further comprises the processing unit being operative to use a device capable of producing the accessibility information in at least one of audible form and Braille form.

34. The system of claim 28, wherein the processing unit being operative to provide the accessibility information further comprises the processing unit being operative to provide the accessibility information comprising at least one of layout information associated with the at least one screen and content information associated with the at least one screen.

35. The system of claim 28, wherein the processing unit being operative to access the accessibility information based on the identification further comprises the processing unit being operative to access the accessibility information based on the identification wherein the identification was created using a hash algorithm.

36. The system of claim 28, wherein the processing unit being operative to provide the accessibility information further comprises the processing unit being operative to provide the accessibility information created through human observation of the at least one screen.

37. A computer-readable medium which stores a set of instructions which when executed performs a method for adapting data from a user interface, the method executed by the set of instructions comprising:
creating an identification associated with at least one screen on the user interface, the at least one screen being produced by an executed software module;
receiving accessibility information associated with the at least one screen; and
storing the identification and the accessibility information.

38. The computer-readable medium of claim 37, wherein receiving the accessibility information further comprises receiving the accessibility information configured to be perceivable by a user having a disability.

39. The computer-readable medium of claim 37, wherein receiving the accessibility information further comprises receiving the accessibility information configured to be perceivable by a user having a disability comprising the inability to perceive at least one human sense.

40. The computer-readable medium of claim 37, wherein receiving the accessibility information further comprises receiving the accessibility information configured to be perceivable by a user having a disability comprising the inability to perceive at least one of sight and sound.

41. The computer-readable medium of claim 37, wherein receiving the accessibility information further comprises receiving the accessibility information configured to be used by a screen reader.

42. The computer-readable medium of claim 37, wherein receiving the accessibility information further comprises receiving the accessibility information configured to be used by a device capable of reproducing the accessibility information in at least one of audible form and Braille form.

43. The computer-readable medium of claim 37, wherein receiving the accessibility information further comprises receiving the accessibility information comprising at least one of layout information associated with the at least one screen and content information associated with the at least one screen.

44. The computer-readable medium of claim 37, wherein creating the identification further comprises using a hash algorithm.

45. The computer-readable medium of claim 37, further comprising creating the accessibility information through human observation of the at least one screen.

46. A computer-readable medium which stores a set of instructions which when executed performs a computer-readable medium for adapting data from a user interface, the computer-readable medium executed by the set of instructions comprising:
driving the user interface with an executed software module, the user interface configured to display at least one screen, the at least one screen having an identification;
accessing accessibility information based on the identification; and
providing the accessibility information.

47. The computer-readable medium of claim 46, wherein providing the accessibility information further comprises providing the accessibility information configured to be perceivable by a user having a disability.

48. The computer-readable medium of claim 46, wherein providing the accessibility information further comprises providing the accessibility information configured to be perceivable by a user having a disability comprising the inability to perceive at least one human sense.

49. The computer-readable medium of claim 46, wherein providing the accessibility information further comprises providing the accessibility information configured to be perceivable by a user having a disability comprising the inability to perceive at least one of sight and sound.

50. The computer-readable medium of claim 46, wherein providing the accessibility information further comprises using a screen reader.

51. The computer-readable medium of claim 46, wherein providing the accessibility information further comprises providing the accessibility using a device capable of producing the accessibility information in at least one of audible form and Braille form.

52. The computer-readable medium of claim 46, wherein providing the accessibility information further comprises providing the accessibility information comprising at least one of layout information associated with the at least one screen and content information associated with the at least one screen.

53. The computer-readable medium of claim 46, wherein accessing accessibility information based on the identification further comprises accessing accessibility information based on the identification wherein the identification was created using a hash algorithm.

54. The computer-readable medium of claim 46, wherein providing the accessibility information further comprises providing the accessibility information created through human observation of the at least one screen.
